(19) United States
(12) Patent Application Publication
(10) Pub. No.: US 2021/0138280 A1
(43) Pub. Date: May 13, 2021

(54) Fall Arrest Assembly

(71) Applicant: Shannon Stewart, Choudrant, LA (US)

(72) Inventor: Shannon Stewart, Choudrant, LA (US)

(21) Appl. No.: 16/681,989

(22) Filed: Nov. 13, 2019

(51) Int. Cl. A62B 35/00

(52) U.S. Cl. CPC A62B 35/0075; A62B 35/0018; A01M 31/02; A62B 35/0068; A62B 35/0037

(57) ABSTRACT

A fall arrest assembly includes a pole that is mountable to a tree. A pair of mounts is provided and each of the mounts is mountable to the tree. Each of the mounts engages the pole for mounting the pole to the tree. A body harness is provided that is wearable on a user. A slide is slidably positionable on the pole when the pole is mounted to the tree. The slide frictionally engages the pole when more than a trigger force is exerted on the slide such that the slide resists sliding on the pole. A lanyard is removably attachable between the body harness and the slide. The slide is exposed to a force that exceeds the trigger force when the lanyard supports the weight of the user. In this way the slide inhibits the user from falling rapidly to the ground when the user falls from the tree stand.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to fall arrest devices and more particularly pertains to a new safety device for protecting a user from injury due to falling from a tree stand.

### (2) Description of Related Art Including Information Disclosed Under 37 CFR 1.97 and 1.98

The prior art relates to fall arrest devices.

### BRIEF SUMMARY OF THE INVENTION

An embodiment of the disclosure meets the needs presented above by generally comprising a pole that is mountable to a tree. A pair of mounts is provided and each of the mounts is mountable to the tree. Each of the mounts engages the pole for mounting the pole to the tree. A body harness is provided that is wearable on a user. A slide is slidably positionable on the pole when the pole is mounted to the tree. The slide frictionally engages the pole when more than a trigger force is exerted on the slide such that the slide resists sliding on the pole. A lanyard is removably attachable between the body harness and the slide. The slide is exposed to a force that exceeds the trigger force when the lanyard supports the weight of the user. In this way the slide inhibits the user from falling rapidly to the ground when the user falls from the tree stand.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a perspective view of a fall arrest assembly according to an embodiment of the disclosure.

FIG. 2 is a perspective view of a body harness of an embodiment of the disclosure.

FIG. 3 is a right side view of a body harness of an embodiment of the disclosure.

FIG. 4 is a cut away view of a pole and a slide of an embodiment of the disclosure.

FIG. 5 is a left side in-use view of an embodiment of the disclosure showing a pole and a tree stand being mounted to a tree.

FIG. 6 is a perspective in-use view of an embodiment of the disclosure.

### DETAILED DESCRIPTION OF THE INVENTION

With reference now to the drawings, and in particular to FIGS. 1 through 6 thereof, a new fall arrest device embodying the principles and concepts of an embodiment of the disclosure and generally designated by the reference numeral 10 will be described.

As best illustrated in FIGS. 1 through 6, the fall arrest assembly 10 generally comprises a pole 12 that is mountable to a tree 14 having the pole 12 being vertically oriented. In this way the pole 12 is structurally independent from a tree stand 16 that may mounted in the tree 14. The tree stand 16 may be a hunting tree stand of any conventional design. The pole 12 has a first end 18, a second end 20 and an outer surface 22 extending therebetween. Additionally, the pole 12 may have a length ranging between approximately 10.0 feet and 20.0 feet.

A pair of mounts 24 is provided and each of the mounts 24 is mountable to the tree 14. Each of the mounts 24 engages the pole 12 for mounting the pole 12 to the tree 14. The mounts 24 are spaced apart from each other and are vertically distributed on the tree 14. Each of the mounts 24 comprises a panel 26 that has a first surface 28 and a second surface 30. The first surface 28 is concavely arcuate thereby facilitating the first surface 28 to conform to curvature of a trunk of the tree 14.

Each of the mounts 24 includes a support 32 that is coupled to and extends away from the second surface 30 of the panel 26. The support 32 has a distal end 34 with respect to the second surface 30. Additionally, the support 32 has a slot 36 extending therethrough thereby facilitating a strap to be passed through the support 32. Each of the mounts 24 includes a sleeve 40 that has a top end 42, a bottom end 44 and an outer wall 46 extending therebetween. The outer wall 46 is coupled to the distal end 34 of the support 32 having the sleeve 40 being vertically oriented when the panel 26 is positioned on the tree 14. The sleeve 40 insertably receives the pole 12 for retaining the pole 12 on the tree 14.

Each of the mounts 24 includes a fastener 48, such as a bolt or the like, extending through the outer wall 46 of the sleeve 40. The fastener 48 is tightenable to frictionally engage the pole 12 thereby inhibiting the pole 12 from sliding out of the sleeve 40. Each of the mounts 24 includes a strap 50 that is extendable around the tree 14. The strap 50 is extendable through the slot 36 in the support 32 having the strap 50 lying against the second surface 30 of the panel 26. In this way the strap 50 can be tightened around the tree 14 for compressing the panel 26 against the tree 14. The strap 50 may be a ratcheting strap, a cargo strap or any other appropriate strap for tightening the panel 26 on the tree 14.

A body harness 52 provided and the body harness 52 is wearable on a user. The body harness 52 has a pair of shoulder straps 54 for extending over the user's shoulders. The body harness 52 has a pair of leg straps 56 for extending around each of the user's legs. Each of the shoulder straps 54 and each of the leg straps 56 are coupled to a back panel 58 that is positioned on the user's back when the body harness 52 is worn. The body harness 52 includes a waist strap 60 that is extendable around the user's waist. The body harness 52 includes a connection point 62 that is positioned on the back panel 58. The connection point 62 may comprise an eye bolt or other connection point that can be engaged with a D-ring or other similar releasable coupler.

A slide 64 is provided and the slide 64 is slidably positionable on the pole 12 when the pole 12 is mounted to the tree 14. The slide 64 freely slides along the pole 12 when less than a trigger force is exerted on the slide 64. Conversely, the slide 64 frictionally engages the pole 12 when more than the trigger force is exerted on the slide 64 such that the slide 64 resists sliding on the pole 12. The trigger force may be a force that is equivalent to approximately 9.0 kg.

The slide 64 comprises a tube 66 that is slidably positionable around the pole 12. The tube 66 has an inside surface 68, an outside surface 70, a top end 72 and a bottom end 74. The slide 64 includes a wedge 76 that is coupled to and extends away from the outside surface 70 of the tube 66. The wedge 76 has a top surface 78, a bottom surface 80 and a front surface 82 extending between the top surface 78 and the bottom surface 80. The wedge 76 may extend through the inside surface 68 of the tube 66 to define a ridge 79 extending between the top end 72 and the bottom end 74 of the tube.

The top surface 78 of the wedge 76 slopes downwardly between the outside surface 70 of the tube 66 and the front surface 82 of the wedge 76. The front surface 82 lies on a plane that is oriented parallel with an axis extending through the top end 72 and the bottom end 74 of the tube 66. Additionally, the front surface 82 of the wedge 76 is positioned closer to the bottom end 74 of the tube 66 than the top end 72 of the tube 66. The slide 64 includes an engagement 84 that is coupled to the front surface 82 of the wedge 76. The engagement 84 may comprise an eyebolt or other fastener that can be engaged by a D-ring or other similar releasable coupler.

A lanyard 86 is provided that is removably attachable between the body harness 52 and the slide 64. The slide 64 is exposed to a force that exceeds the trigger force when the lanyard 86 support 32s the weight of the user. In this way the slide 64 is inhibits the user from falling rapidly to the ground when the user falls from the tree stand 16. Thus, the user is protected from serious injury when the user falls from the tree stand 16. The lanyard 86 is coupled between the connection point 62 on the back panel 26 of the body harness 52 and the engagement 84 on the front surface 82 of the wedge 76. The tube 66 is forced into an offset angle with respect to the pole 12 when the trigger force is applied to the slide 64. Thus, ridge 79 on the inside surface 68 of the tube 66 frictionally engages the outer surface 22 of the pole 12 to inhibit the slide 64 from sliding downwardly on the pole 12.

In use, the slide 64 is positioned on the pole 12 and the pole 12 is inserted through the sleeve 40 on each of the mounts 24. Each of the mounts 24 is subsequently mounted to the tree 14. In this way the pole 12 is structurally independent from the tree stand 16 that is mounted in the tree 14. The user wears the body harness 52 and the user connects the lanyard 86 between the body harness 52 and the slide 64. In this way the slide 64 inhibits the user from rapidly falling to the ground when the user falls from the tree stand 16. Thus, the user is protected from serious injury that could otherwise occur from falling out of the tree stand 16.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A fall arrest assembly being configured to be attached to a tree in conjunction with a tree stand thereby facilitating a hunter to attach a body harness to the tree, said assembly comprising:
a pole being mountable to a tree having said pole being vertically oriented wherein said pole is configured to be structurally independent from a tree stand mounted in the tree;
a pair of mounts, each of said mounts being mountable to the tree, each of said mounts engaging said pole for mounting said pole to the tree, said mounts being spaced apart from each other and being vertically distributed on the tree;
a body harness being wearable on a user;
a slide being slidably positionable on said pole when said pole is mounted to the tree, said slide sliding freely along said pole when less than a trigger force is exerted on said slide, said slide frictionally engaging said pole when more than the trigger force is exerted on said slide such that said slide resists sliding on said pole; and
a lanyard being removably attachable between said body harness and said slide, said slide being exposed to a force that exceeds said trigger force when the lanyard supports the weight of the user wherein said slide is configured to inhibit the user from falling rapidly to the ground when the user falls from the tree stand.

2. The assembly according to claim 1, wherein each of said mounts comprises a panel having a first surface and a second surface, said first surface being concavely arcuate thereby facilitating said first surface to conform to curvature of a trunk of the tree.

3. The assembly according to claim 2, wherein each of said mounts comprises a support being coupled to and extending away from said second surface of said panel, said support having a distal end with respect to said second surface, said support having a slot extending therethrough thereby facilitating a strap to be passed through said support.

4. The assembly according to claim 3, wherein each of said mounts comprises a sleeve having a top end, a bottom end and an outer wall extending therebetween, said outer wall being coupled to said distal end of said support having said sleeve being vertically oriented when said panel is positioned on the tree, said sleeve insertably receiving said pole for retaining said pole on the tree.

5. The assembly according to claim 4, wherein each of said mounts comprises a fastener extending through said outer wall of said sleeve, said fastener being tightenable to frictionally engaging said pole thereby inhibiting said pole from sliding out of said sleeve.

6. The assembly according to claim 5, wherein each of said mounts comprises a strap being extendable around the tree, said strap being extendable through said slot in said support having said strap lying against said second surface of said panel, said strap being tightenable around the tree for compressing said panel against the tree.

7. The assembly according to claim 1, wherein said body harness has a pair of shoulder straps for extending over the user's shoulders, said body harness having a pair of leg straps for extending around each of the user's legs, each of said shoulder straps and each of said leg straps being coupled to a back panel being positioned on the user's back when said body harness is worn, said body harness including a waist strap being extendable around the user's waist, said body harness including a connection point being positioned on said back panel.

8. The assembly according to claim 7, wherein:
said pole has a first end, a second end and an outer surface extending therebetween; and
said slide comprises a tube being slidably positionable around said pole, said tube having an inside surface, an outside surface, a top end and a bottom end.

9. The assembly according to claim 8, wherein said slide comprises a wedge being coupled to and extending away from said outside surface of said tube, said wedge having a top surface, a bottom surface and a front surface extending between said top surface and said bottom surface, said top surface sloping downwardly between said outside surface of said tube and said front surface of said wedge, said front surface lying on a plane being oriented parallel with an axis extending through said top end and said bottom end of said tube, said front surface of said wedge being positioned closer to said bottom end of said tube than said top end of said tube.

10. The assembly according to claim 9, wherein said slide comprises an engagement being coupled to said front surface of said wedge.

11. The assembly according to claim 10, wherein said lanyard is coupled between said connection point on said back panel of said body harness and said engagement on said front surface of said wedge.

12. The assembly according to claim 11, wherein said tube is forced into an offset angle with respect to said pole when said trigger force is applied to said slide such that said inside surface of said tube frictionally engages said outer surface of said pole.

13. A fall arrest assembly being configured to be attached to a tree in conjunction with a tree stand thereby facilitating a hunter to attach a body harness to the tree, said assembly comprising:
a pole being mountable to a tree having said pole being vertically oriented wherein said pole is configured to be structurally independent from a tree stand mounted in the tree, said pole having a first end, a second end and an outer surface extending therebetween;
a pair of mounts, each of said mounts being mountable to the tree, each of said mounts engaging said pole for mounting said pole to the tree, said mounts being spaced apart from each other and being vertically distributed on the tree, each of said mounts comprising:
a panel having a first surface and a second surface, said first surface being concavely arcuate thereby facilitating said first surface to conform to curvature of a trunk of the tree;
a support being coupled to and extending away from said second surface of said panel, said support having a distal end with respect to said second surface, said support having a slot extending therethrough thereby facilitating a strap to be passed through said support;
a sleeve having a top end, a bottom end and an outer wall extending therebetween, said outer wall being coupled to said distal end of said support having said sleeve being vertically oriented when said panel is positioned on the tree, said sleeve insertably receiving said pole for retaining said pole on the tree;
a fastener extending through said outer wall of said sleeve, said fastener being tightenable to frictionally engaging said pole thereby inhibiting said pole from sliding out of said sleeve; and
a strap being extendable around the tree, said strap being extendable through said slot in said support having said strap lying against said second surface of said panel, said strap being tightenable around the tree for compressing said panel against the tree;
a body harness being wearable on a user, said body harness having a pair of shoulder straps for extending over the user's shoulders, said body harness having a pair of leg straps for extending around each of the user's legs, each of said shoulder straps and each of said leg straps being coupled to a back panel being positioned on the user's back when said body harness is worn, said body harness including a waist strap being extendable around the user's waist, said body harness including a connection point being positioned on said back panel;
a slide being slidably positionable on said pole when said pole is mounted to the tree, said slide sliding freely along said pole when less than a trigger force is exerted on said slide, said slide frictionally engaging said pole when more than the trigger force is exerted on said slide such that said slide resists sliding on said pole, said slide comprising:
a tube being slidably positionable around said pole, said tube having an inside surface, an outside surface, a top end and a bottom end;
a wedge being coupled to and extending away from said outside surface of said tube, said wedge having a top surface, a bottom surface and a front surface extending between said top surface and said bottom surface, said top surface sloping downwardly between said outside surface of said tube and said front surface of said wedge, said front surface lying on a plane being oriented parallel with an axis extending through said top end and said bottom end of said tube, said front surface of said wedge being positioned closer to said bottom end of said tube than said top end of said tube; and
an engagement being coupled to said front surface of said wedge; and
a lanyard being removably attachable between said body harness and said slide, said slide being exposed to a force that exceeds said trigger force when the lanyard supports the weight of the user wherein said slide is configured to inhibit the user from falling rapidly to the ground when the user falls from the tree stand, said lanyard being coupled between said connection point on said back panel of said body harness and said engagement on said front surface of said wedge, said tube being forced into an offset angle with respect to said pole when the trigger force is applied to said slide such that said inside surface of said tube frictionally engages said outer surface of said pole.
